(19) United States
(12) Patent Application Publication
(10) Pub. No.: US 2015/0338523 A1
(43) Pub. Date: Nov. 26, 2015

(54) Electronic Device Having Array of Satellite Navigation System Antennas

(71) Applicant: Apple Inc., Cupertino, CA (US)

(72) Inventors: Harish Rajagopalan, Cupertino, CA (US); Jiang Zhu, Sunnyvale, CA (US); Qingxiang Li, Mountain View, CA (US); Robert W. Schlub, Cupertino, CA (US); Rodney A. Gomez Angulo, Sunnyvale, CA (US)

(73) Assignee: Apple Inc., Cupertino, CA (US)

(21) Appl. No.: 14/285,321

(22) Filed: May 22, 2014

(51) Int. Cl. G01S 19/37

(52) U.S. Cl. CPC G01S 19/37

(57) ABSTRACT

An electronic device may be provided with wireless circuitry. The wireless circuitry may include a pair of antennas. The antennas may be formed from inverted-F antenna resonating elements located along one of the peripheral edges of a device housing. The housing may be formed of metal and may serve as an antenna ground for the antennas. The antennas may be used to receive satellite navigation system signals that are processed by a satellite navigation system receiver. An orientation sensor may be used to gather information on the orientation of the electronic device relative to the Earth. Information on received signal strength may be obtained from the satellite navigation system receiver. Based on orientation information or received signal strength information or other information, switching circuitry may be adjusted to switch an optimum one of the antennas into use or phase shifter circuitry may be adjusted to optimize signal reception.

### BACKGROUND

This relates generally to electronic devices and, more particularly, to electronic devices with wireless communications circuitry.

Electronic devices often include wireless communications circuitry. For example, cellular telephones, computers, and other devices often contain antennas and wireless transceivers for supporting wireless communications.

It can be challenging to form electronic device antenna structures with desired attributes. In some wireless devices, the presence of conductive housing structures can influence antenna performance. For example, the presence of conductive housing structures or other device structures may impart directionality to an antenna. If care is not taken, directionality may adversely affect antenna operations. For example, the antenna may not always be oriented in a direction that optimizes signal reception. As a result, antenna performance may be poorer than desired when the antenna is pointed in certain directions.

It would therefore be desirable to be able to provide improved wireless circuitry for electronic devices.

### SUMMARY

An electronic device may be provided with wireless circuitry. The wireless circuitry may include a pair of antennas and a satellite navigation system receiver. The antennas and satellite navigation system receiver may be used in receiving satellite navigation system signals. The satellite navigation system signals may be used by mapping applications and other location-based services operating on the electronic device.

The electronic device may have a housing such as a metal electronic device housing having four peripheral edges. The antennas may be formed from inverted-F antenna resonating elements located along one of the peripheral edges of the housing. The housing may serve as an antenna ground for the antennas. The antennas may be inverted-F antennas having inverted-F antenna resonating elements supported by a dielectric support structure.

An orientation sensor may be used to gather information on the orientation of the electronic device relative to the Earth. Information on received signal strength may be obtained from the satellite navigation system receiver. Switching circuitry may be adjusted to switch an optimum one of the antennas into use based on orientation information, received signal strength information, or other information gathered during operation of the electronic device. In another arrangement, both antennas are in active use at the same time and phase shifter circuitry is interposed in a path between one of the antennas and the satellite navigation system receiver. With this arrangement, the phase shifter circuitry may be adjusted in real time to optimize antenna performance. Configurations with a fixed phase shift between antennas may also be used.

### BRIEF DESCRIPTION OF THE DRAWINGS

FIG. 1 is a perspective view of an illustrative electronic device with wireless communications circuitry in accordance with an embodiment.

FIG. 2 is a schematic diagram of an illustrative electronic device with wireless communications circuitry in accordance with an embodiment.

FIG. 3 is a diagram of illustrative wireless circuitry in accordance with an embodiment.

FIG. 4 is a diagram of an illustrative antenna in accordance with an embodiment.

FIG. 5 is a diagram showing an illustrative portrait orientation in which an electronic device of the type shown in FIG. 1 may be used in accordance with an embodiment.

FIG. 6 is a diagram showing an illustrative flat up orientation in which an electronic device of the type shown in FIG. 1 may be used in accordance with an embodiment.

FIG. 7 is a diagram showing an illustrative home button right orientation in which an electronic device of the type shown in FIG. 1 may be used in accordance with an embodiment.

FIG. 8 is a diagram showing an illustrative home button left orientation in which an electronic device of the type shown in FIG. 1 may be used in accordance with an embodiment.

FIG. 9 is a perspective view of a portion of an electronic device having a pair of antennas in accordance with an embodiment.

FIG. 10 is a schematic diagram of an illustrative electronic device of the type shown in FIG. 9 that has been provided with switching circuitry for switching an optimum antenna into use in accordance with an embodiment.

FIG. 11 is a table of illustrative antenna selections that may be made as a function of measured device orientation in accordance with an embodiment.

FIG. 12 is a flow chart of illustrative steps involved in operating an electronic device of the type shown in FIG. 10 in accordance with an embodiment.

FIG. 13 is a schematic diagram of an illustrative electronic device of the type shown in FIG. 9 that has been provided with an adjustable phase shifter for ensuring optimum operation of a pair of antennas in accordance with an embodiment.

FIG. 14 is a table of illustrative phase shift settings that may be used for the antenna array of FIG. 13 in accordance with an embodiment.

FIG. 15 is a flow chart of illustrative steps involved in operating an electronic device of the type shown in FIG. 13 in accordance with an embodiment.

### DETAILED DESCRIPTION

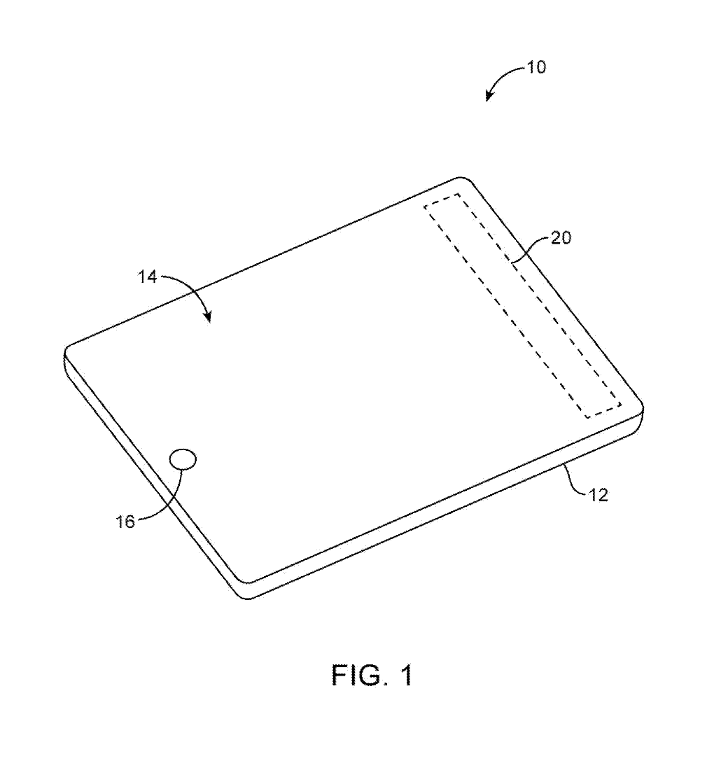

An electronic device such as electronic device 10 of FIG. 1 may contain wireless circuitry. The wireless circuitry may include antenna structures and satellite navigation system circuitry for handling satellite navigation system signals. The satellite navigation system circuitry may, for example, include a Global Position System (GPS) receiver that handles GPS satellite navigation system signals at 1575 MHz or a GLONASS receiver that handles GLONASS signals at 1609 MHz. Device 10 may also contain wireless communications circuitry that operates in communications bands such as cellular telephone bands and wireless circuitry that operates in communications bands such as the 2.4 GHz Bluetooth® band and the 2.4 GHz and 5 GHz WiFi® wireless local area network bands (sometimes referred to as IEEE 802.11 bands or wireless local area network communications bands). If desired, device 10 may also contain wireless communications circuitry for implementing near-field communications, light-based wireless communications, or other wireless communications.

Electronic device 10 may be a computing device such as a laptop computer, a computer monitor containing an embedded computer, a tablet computer, a cellular telephone, a media player, or other handheld or portable electronic device, a smaller device such as a wrist-watch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, or other electronic equipment. In the illustrative configuration of FIG. 1, device 10 is a portable device such as a cellular telephone, media player, tablet computer, or other portable computing device. Other configurations may be used for device 10 if desired. The example of FIG. 1 is merely illustrative.

In the example of FIG. 1, device 10 includes a display such as display 14. Display 14 has been mounted in a housing such as housing 12. Housing 12, which may sometimes be referred to as an enclosure or case, may be formed of plastic, glass, ceramics, fiber composites, metal (e.g., stainless steel, aluminum, etc.), other suitable materials, or a combination of any two or more of these materials. Housing 12 may be formed using a unibody configuration in which some or all of housing 12 is machined or molded as a single structure or may be formed using multiple structures (e.g., an internal frame structure, one or more structures that form exterior housing surfaces, etc.).

Display 14 may be a touch screen display that incorporates a layer of conductive capacitive touch sensor electrodes or other touch sensor components (e.g., resistive touch sensor components, acoustic touch sensor components, force-based touch sensor components, light-based touch sensor components, etc.) or may be a display that is not touch-sensitive. Capacitive touch screen electrodes may be formed from an array of indium tin oxide pads or other transparent conductive structures.

Display 14 may include an array of display pixels formed from liquid crystal display (LCD) components, an array of electrophoretic display pixels, an array of plasma display pixels, an array of organic light-emitting diode display pixels, an array of electrowetting display pixels, or display pixels based on other display technologies.

Display 14 may be protected using a display cover layer such as a layer of transparent glass or clear plastic. Openings may be formed in the display cover layer. For example, an opening may be formed in the display cover layer to accommodate a button such as button 16. An opening may also be formed in the display cover layer to accommodate ports such as a speaker port. Openings may be formed in housing 12 to form communications ports (e.g., an audio jack port, a digital data port, etc.). Openings in housing 12 may also be formed for audio components such as a speaker and/or a microphone. Antennas may be mounted in housing 12. For example, housing 12 may have four peripheral edges as shown in FIG. 1 and a pair of antennas may be mounted along one of these peripheral housing edges. As shown in the illustrative configuration of FIG. 1, a pair of antennas may, if desired, be mounted in region 20 along the peripheral edge of housing 12 that is opposite to the edge of housing 12 adjacent to button 16.

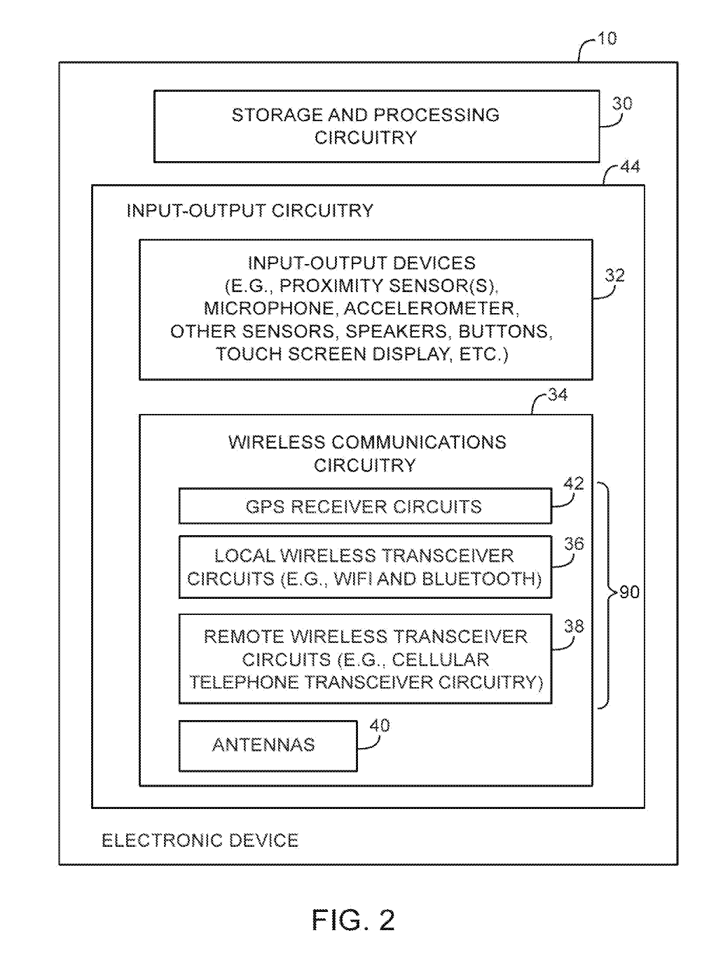

A schematic diagram showing illustrative components that may be used in device 10 is shown in FIG. 2. As shown in FIG. 2, device 10 may include control circuitry such as storage and processing circuitry 30. Storage and processing circuitry 30 may include storage such as hard disk drive storage, nonvolatile memory (e.g., flash memory or other electrically-programmable-read-only memory configured to form a solid state drive), volatile memory (e.g., static or dynamic random-access-memory), etc. Processing circuitry in storage and processing circuitry 30 may be used to control the operation of device 10. This processing circuitry may be based on one or more microprocessors, microcontrollers, digital signal processors, baseband processor integrated circuits, application specific integrated circuits, etc.

Storage and processing circuitry 30 may be used to run software on device 10, such as internet browsing applications, voice-over-internet-protocol (VOIP) telephone call applications, email applications, media playback applications, operating system functions, etc. To support interactions with external equipment, storage and processing circuitry 30 may be used in implementing communications protocols. Communications protocols that may be implemented using storage and processing circuitry 30 include internet protocols, wireless local area network protocols (e.g., IEEE 802.11 protocols—sometimes referred to as WiFi®), protocols for other short-range wireless communications links such as the Bluetooth® protocol, cellular telephone protocols, MIMO protocols, antenna diversity protocols, satellite navigation system protocols, etc.

Device 10 may include input-output circuitry 44. Input-output circuitry 44 may include input-output devices 32. Input-output devices 32 may be used to allow data to be supplied to device 10 and to allow data to be provided from device 10 to external devices. Input-output devices 32 may include user interface devices, data port devices, and other input-output components. For example, input-output devices may include touch screens, displays without touch sensor capabilities, buttons, joysticks, click wheels, scrolling wheels, touch pads, key pads, keyboards, microphones, cameras, speakers, status indicators, light sources, audio jacks and other audio port components, digital data port devices, light sensors, accelerometers or other components that can detect motion and device orientation relative to the Earth, capacitance sensors, proximity sensors (e.g., a capacitive proximity sensor and/or an infrared proximity sensor), magnetic sensors, a connector port sensor or other sensor that determines whether device 10 is mounted in a dock, and other sensors and input-output components.

Input-output circuitry 44 may include wireless communications circuitry 34 for communicating wirelessly with external equipment. Wireless communications circuitry 34 may include radio-frequency (RF) transceiver circuitry formed from one or more integrated circuits, power amplifier circuitry, low-noise input amplifiers, passive RF components, one or more antennas 40, transmission lines, and other circuitry for handling RF wireless signals. Wireless signals can also be sent using light (e.g., using infrared communications).

Wireless communications circuitry 34 may include radio-frequency transceiver circuitry 90 for handling various radio-frequency communications bands. For example, circuitry 34 may include transceiver circuitry 36, 38, and 42.

Transceiver circuitry 36 may be wireless local area network transceiver circuitry that may handle 2.4 GHz and 5 GHz bands for WiFi® (IEEE 802.11) communications and that may handle the 2.4 GHz Bluetooth® communications band.

Circuitry 34 may use cellular telephone transceiver circuitry 38 for handling wireless communications in frequency ranges such as a low communications band from 700 to 960 MHz, a midband from 1710 to 2170 MHz, and a high band from 2300 to 2700 MHz or other communications bands between 700 MHz and 2700 MHz or other suitable frequencies (as examples). Circuitry 38 may handle voice data and non-voice data.

Wireless communications circuitry 34 can include circuitry for other short-range and long-range wireless links if desired. For example, wireless communications circuitry 34 may include 60 GHz transceiver circuitry, circuitry for receiving television and radio signals, paging system transceivers, near field communications (NFC) circuitry, etc.

Wireless communications circuitry 34 may include satellite navigation system circuitry such as global positioning system (GPS) receiver circuitry 42 for receiving GPS signals at 1575 MHz or for handling other satellite positioning data (e.g., GLONASS signals at 1609 MHz). In WiFi® and Bluetooth® links and other short-range wireless links, wireless signals are typically used to convey data over tens or hundreds of feet. In cellular telephone links and other long-range links, wireless signals are typically used to convey data over thousands of feet or miles. Satellite navigation system signals for receiver 42 are received from a constellation of satellites orbiting the earth. Signals are transmitted from these satellites using right-hand circular polarization.

Antennas 40 in wireless communications circuitry 34 may be formed using any suitable antenna types. For example, antennas 40 may include antennas with resonating elements that are formed from loop antenna structures, patch antenna structures, inverted-F antenna structures, slot antenna structures, planar inverted-F antenna structures, helical antenna structures, hybrids of these designs, etc. If desired, one or more of antennas 40 may be cavity-backed antennas. Different types of antennas may be used for different bands and combinations of bands. For example, one type of antenna may be used in forming a local wireless link antenna and another type of antenna may be used in forming a remote wireless link antenna. Dedicated antennas may be used for receiving satellite navigation system signals or, if desired, antennas 40 can be configured to receive both satellite navigation system signals and signals for other communications bands (e.g., wireless local area network signals and/or cellular telephone signals).

Transmission line paths may be used to couple antenna structures 40 to transceiver circuitry 90. Transmission lines in device 10 may include coaxial cable paths, microstrip transmission lines, stripline transmission lines, edge-coupled microstrip transmission lines, edge-coupled stripline transmission lines, transmission lines formed from combinations of transmission lines of these types, etc. Filter circuitry, switching circuitry, impedance matching circuitry, and other circuitry may be interposed within the transmission lines, if desired.

Device 10 may contain multiple antennas 40. The antennas may be used together or one of the antennas may be switched into use while the other antenna(s) may be switched out of use. If desired, control circuitry 30 may be used to select an optimum antenna to use in device 10 in real time and/or an optimum setting for a phase shifter or other wireless circuitry coupled to the antennas (e.g., an optimum antenna to receive satellite navigation system signals, etc.). Control circuitry 30 may, for example, make an antenna selection or antenna array phase adjustment based on information on received signal strength, based on sensor data (e.g., orientation information from an accelerometer), based on other sensor information (e.g., information indicating whether device 10 has been mounted in a dock in a portrait orientation), or based on other information about the operation of device 10.

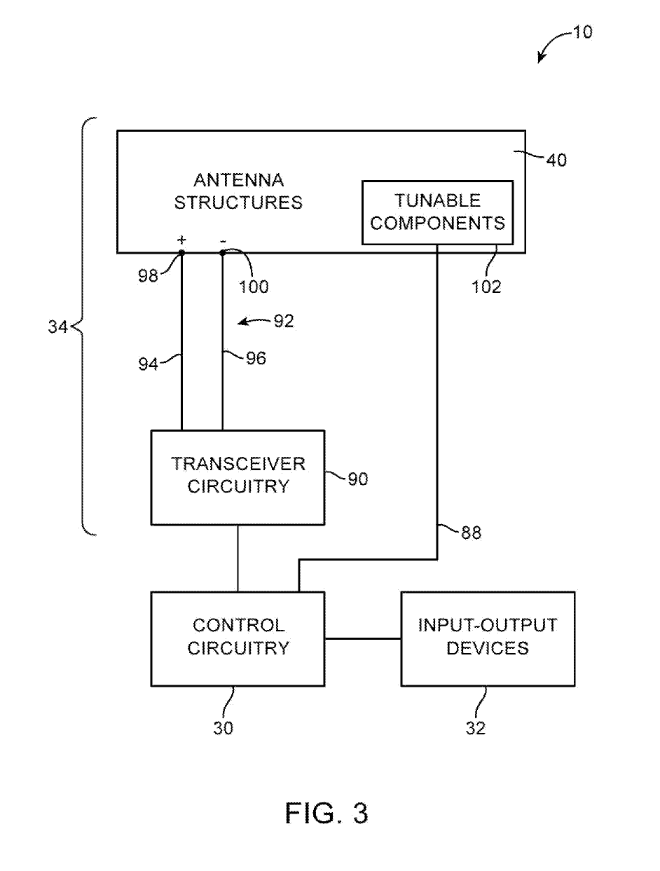

As shown in FIG. 3, transceiver circuitry 90 in wireless circuitry 34 may be coupled to antenna structures 40 using paths such as path 92. Wireless circuitry 34 may be coupled to control circuitry 30. Control circuitry 30 may be coupled to input-output devices 32. Input-output devices 32 may supply output from device 10 and may receive input from sources that are external to device 10.

To provide antenna structures 40 with the ability to cover communications frequencies of interest, antenna structures 40 may be provided with circuitry such as filter circuitry (e.g., one or more passive filters and/or one or more tunable filter circuits). Discrete components such as capacitors, inductors, and resistors may be incorporated into the filter circuitry. Capacitive structures, inductive structures, and resistive structures may also be formed from patterned metal structures (e.g., part of an antenna). If desired, antenna structures 40 may be provided with adjustable circuits such as tunable components 102 to tune antennas over communications bands of interest. Tunable components 102 may include tunable inductors, tunable capacitors, or other tunable components. Tunable components such as these may be based on switches and networks of fixed components, distributed metal structures that produce associated distributed capacitances and inductances, variable solid state devices for producing variable capacitance and inductance values, tunable filters, or other suitable tunable structures. During operation of device 10, control circuitry 30 may issue control signals on one or more paths such as path 88 that adjust inductance values, capacitance values, or other parameters associated with tunable components 102, thereby tuning antenna structures 40 to cover desired communications bands. Configurations in which antennas 40 are fixed (not tunable) may also be used.

Path 92 may include one or more transmission lines. As an example, signal path 92 of FIG. 3 may be a transmission line having a positive signal conductor such as line 94 and a ground signal conductor such as line 96. Lines 94 and 96 may form parts of a coaxial cable or a microstrip transmission line (as examples). A matching network formed from components such as inductors, resistors, and capacitors may be used in matching the impedance of antenna structures 40 to the impedance of transmission line 92. Matching network components may be provided as discrete components (e.g., surface mount technology components) or may be formed from housing structures, printed circuit board structures, traces on plastic supports, etc. Components such as these may also be used in forming filter circuitry in antenna structures 40.

Transmission line 92 may be coupled to antenna feed structures associated with antenna structures 40. As an example, antenna structures 40 may form an inverted-F antenna, a slot antenna, a hybrid inverted-F slot antenna or other antenna having an antenna feed with a positive antenna feed terminal such as terminal 98 and a ground antenna feed terminal such as ground antenna feed terminal 100. Positive transmission line conductor 94 may be coupled to positive antenna feed terminal 98 and ground transmission line conductor 96 may be coupled to ground antenna feed terminal 92. Other types of antenna feed arrangements may be used if desired. The illustrative feeding configuration of FIG. 3 is merely illustrative.

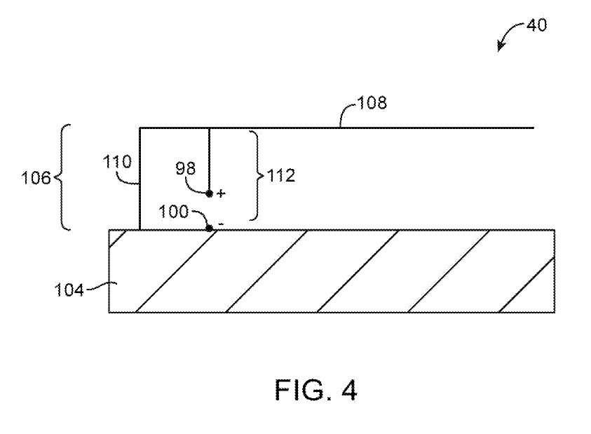

FIG. 4 is a diagram of illustrative inverted-F antenna structures that may be used in implementing antennas 40 for device 10. Inverted-F antenna 40 of FIG. 4 has antenna resonating element 106 and antenna ground (ground plane) 104. Antenna resonating element 106 may have a main resonating element arm such as arm 108. The length of arm 108 may be selected so that antenna 40 resonates at desired operating frequencies. For example, the length of arm 108 may be a quarter of a wavelength at a desired operating frequency for antenna 40. Antenna 40 may also exhibit resonances at harmonic frequencies.

Main resonating element arm 108 may be coupled to ground 104 by return path 110. Antenna feed 112 may include positive antenna feed terminal 98 and ground antenna feed terminal 100 and may run parallel to return path 110 between arm 108 and ground 104. If desired, inverted-F antennas such as illustrative antenna 40 of FIG. 4 may have more than one resonating arm branch (e.g., to create multiple frequency resonances to support operations in multiple communications bands) or may have other antenna structures (e.g., parasitic antenna resonating elements, tunable components such as components 102 of FIG. 3 to support antenna tuning, etc.). Antenna 40 of FIG. 4 may be a planar inverted-F antenna (e.g., arm 108 may have planar metal structures that run into the page in the orientation of FIG. 4) or may be formed from non-planar structures.

Device 10 may have an array of antennas (e.g., a pair of antennas) for receiving satellite navigation system signals. Navigation system signals are circularly polarized and are received from above a user's head (e.g., in a cone pointing upward and having a spread of 120-135°). To optimize the reception of wireless signals such as satellite navigation system signals, wireless circuitry 34 can make real time adjustments to the antenna array based on information such as received signal strength information, device orientation information, and other information about the usage of device 10. These adjustments may be used to optimize signal reception for circularly polarized signals received within the upwardly pointed 120-135° cone.

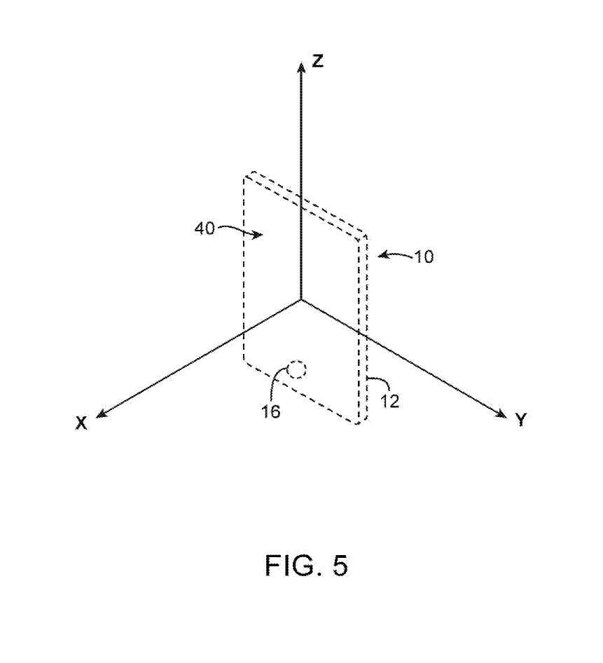

Illustrative orientations in which device 10 may be used are shown in FIGS. 5, 6, 7, and 8. In FIGS. 5, 6, 7, and 8, the Z-axis points directly upwards away from the surface of the Earth. The lateral X-axis and Y-axis lie in a plane that is parallel to the surface of the earth.

In the illustrative orientation of FIG. 5, the end of device 10 that contains home (menu) button 16 is pointed downwards towards the Earth and the opposing upper end of device 10 (which may contain antennas 40) is pointing upwards in direction Z. The orientation of FIG. 5 is sometimes referred to as a portrait orientation, a home button down orientation, or an “antenna end up” orientation.

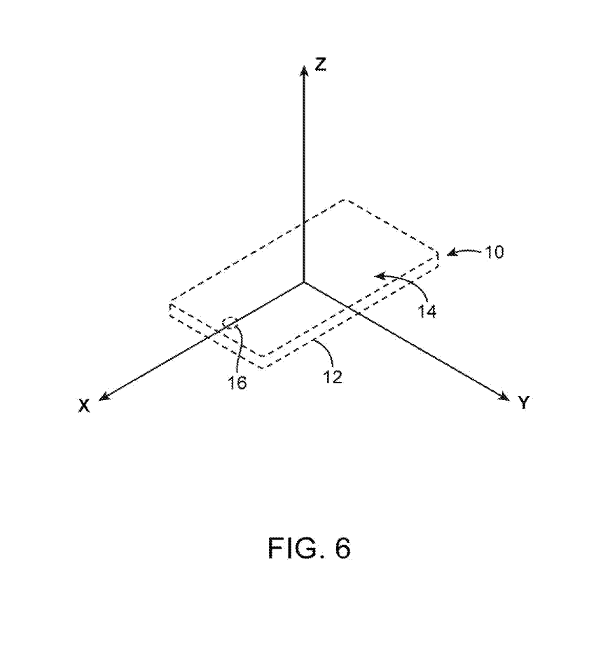

In the illustrative orientation of FIG. 6, the front face of device 10 (i.e., the surface of device 10 that contains home (menu) button 16 and display 14) is pointed upwards towards the satellites orbiting the earth and away from the surface of the Earth. The orientation of FIG. 6 is sometimes referred to as a flat up orientation or “display surface up” orientation.

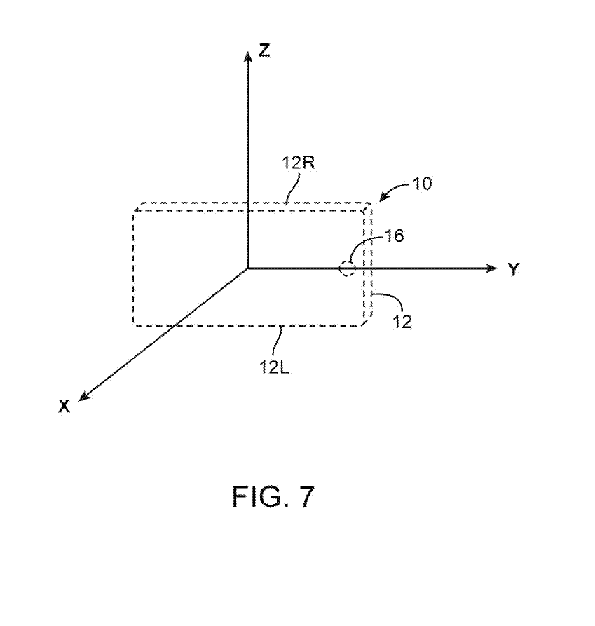

In the illustrative orientation of FIG. 7, the end of device 10 that contains home (menu) button 16 is pointed sideways to the right (i.e., along axis Y in the orientation of FIG. 7). In this orientation, right-hand edge 12R of device 10 is pointing upwards in direction Z and left-hand edge 12L of device 10 is pointing downwards towards the Earth (i.e., in the −Z direction). The orientation of FIG. 7 is sometimes referred to as a home button right orientation or a right-edge up orientation.

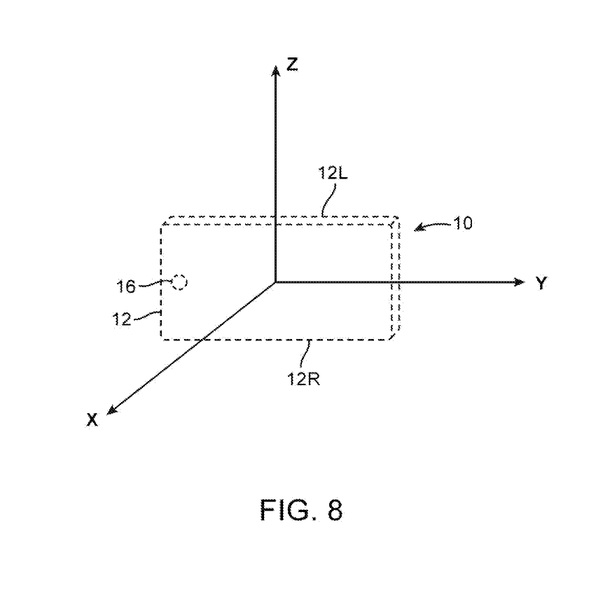

In the illustrative orientation of FIG. 8, the end of device 10 that contains home (menu) button 16 is pointed sideways to the left (i.e., along the negative Y direction in the orientation of FIG. 8). In this orientation, right-hand edge 12R of device 10 is pointing downwards towards the earth in direction −Z and left-hand edge 12L of device 10 is pointing upwards away from the Earth (i.e., in the +Z direction). The orientation of FIG. 8 is sometimes referred to as a home button left orientation or a left-edge up orientation.

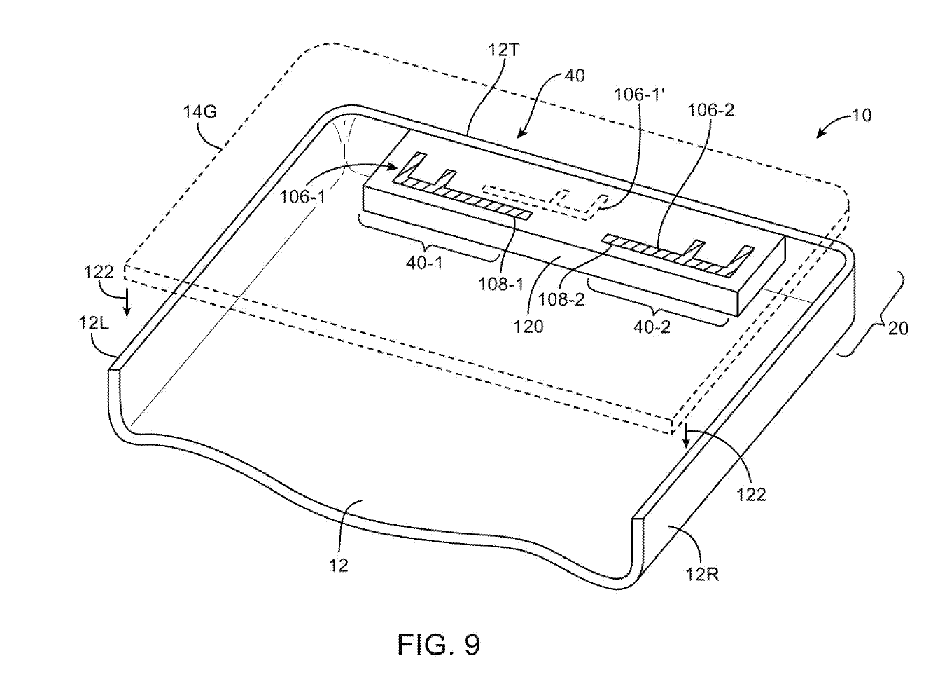

A perspective view of an end portion of device 10 is shown in FIG. 9 (i.e., an end opposite to the end containing button 16). As shown in FIG. 9, device 10 may have a pair of antennas 40 such as antenna 40-1 and antenna 40-2. Antennas 40 may be formed form antenna resonating element structures mounted on dielectric support structures 120 (e.g., a plastic carrier) in region 20 along peripheral edge 12T of housing 12. Display 14 (FIG. 1) may have an outermost layer such as a clear glass or plastic layer (e.g., display cover layer 14G). When assembled in direction 122, display cover layer 14G may lie flush with the front face of device 10 on housing 12, so that antennas 40-1 and 40-2 receive signals through layer 14G.

Housing 12 may be formed from metal or other conductive material. Antenna 40-1 may be formed from antenna resonating element 106-1 and an antenna ground formed from a portion of metal housing 12 adjacent to antenna resonating element 106-1. Antenna 40-2 may be formed from antenna resonating element 106-2 and an antenna ground formed from a portion of metal housing 12 adjacent to antenna resonating element 106-2. Antenna resonating element 106-1 and antenna resonating element 106-2 may be formed from inverted-F antenna resonating element structures or other suitable structures that resonate at satellite navigation system frequencies (e.g., 1575 MHz to 1609 MHz) and/or other communications band frequencies.

The antenna resonating element structures of antennas 40-1 and 40-2 may be formed from metal traces on a printed circuit (e.g., a flexible printed circuit formed from a layer of polyimide or other flexible polymer layer or a rigid printed circuit board formed from a material such as fiberglass-filled epoxy), may be formed from metal traces formed directly on carrier 120, or may be formed from patterned metal foil (as examples). Antenna resonating elements 106-1 and 106-2 may be oriented so that resonating element arms 108-1 and 108-2 run parallel to housing edge 12T. Arms 108-1 and 108-2 may be oriented in the same direction (e.g., with the antenna feeds of antennas 40-1 and 40-1 both facing to the left as illustrated by resonating elements 106-1′ and 106-2 of FIG. 9) or, if desired, the feeds of antennas 40-1 and 40-2 may point in different directions (see, e.g., elements 106-1 and 106-2 of FIG. 9, which have feeds pointing toward each other).

Housing 12, which forms the antenna ground plane for antennas 40 may have a rear portion and sidewall portions. Antennas 40 may be located along edge 12T of housing 12. Due to the different placements of antenna resonating elements 106-1 and 106-2 within housing 12, antennas 40-1 and 40-2 will generally have different polarizations. Antennas 40-1 and 40-2 will also generally exhibit different directionality (enhanced efficiency in particular directions) due to the positions of respective antenna resonating elements 106-1 and 106-2 relative to adjacent portions of housing 12. The different directionality of antennas 40-1 and 40-2 can be exploited to optimize antenna performance over a variety of device orientations (e.g., the illustrative device orientations of FIGS. 5, 6, 7, and 8).

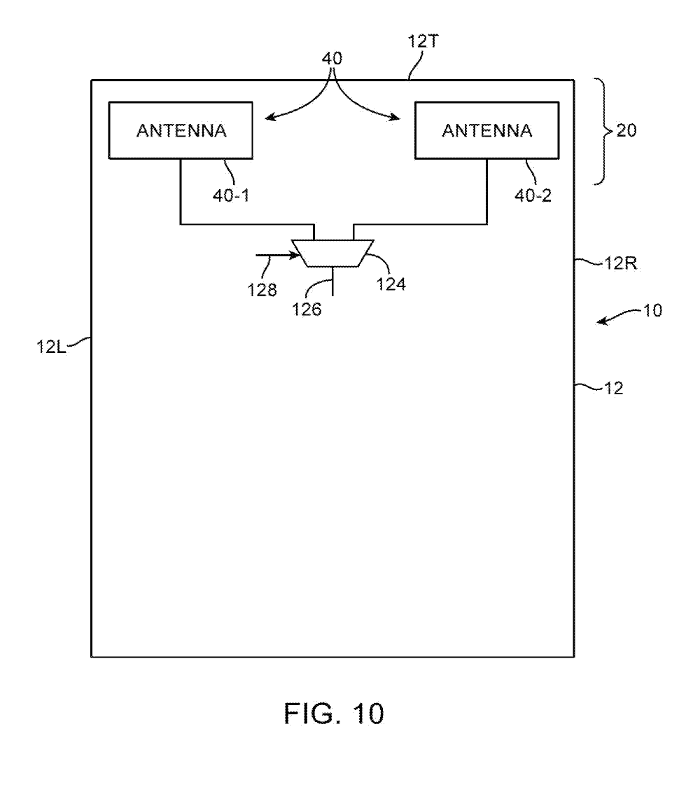

With one suitable arrangement, switching circuitry such as switching circuitry 124 of FIG. 10 is used to switch an optimum antenna into use in real time. Switching circuitry 124 may have inputs coupled to antennas 40-1 and 40-2, respectively. Antennas 40-1 and 40-2 may have their feeds facing towards each other, as shown by elements 106-1 and 106-2 of FIG. 9 or may have their feeds facing in the same direction, as shown by elements 106-1′ and 106-2 (as examples). Output 126 of switching circuitry 124 may be provided to a satellite navigation system receiver such as receiver 42 of FIG. 2 (e.g., a GPS receiver or a GLONASS receiver). Control signals from control circuitry 30 may be supplied to control input 128 of switching circuitry 124 to direct switching circuitry 124 to couple either antenna 40-1 or antenna 40-2 to receiver 42 for use as the active satellite navigation system antenna in device 10. Control circuitry 30 can use sensor signals, received signal strength information, or other information to determine how to adjust switching circuitry 124 (i.e., to determine which of antennas 40-1 and 40-2 should be switched into use as the active satellite navigation system antenna for device 10).

During antenna characterization operations, the directionality of antennas 40-1 and 40-2 may be measured. Because each antenna has a different efficiency pattern, the orientation of device 10 will affect which antenna is optimum at any given point in time. As a user positions device 10 in different orientations relative to the Earth during the use of device 10, an optimum antenna can be selected in real time for each different orientation.

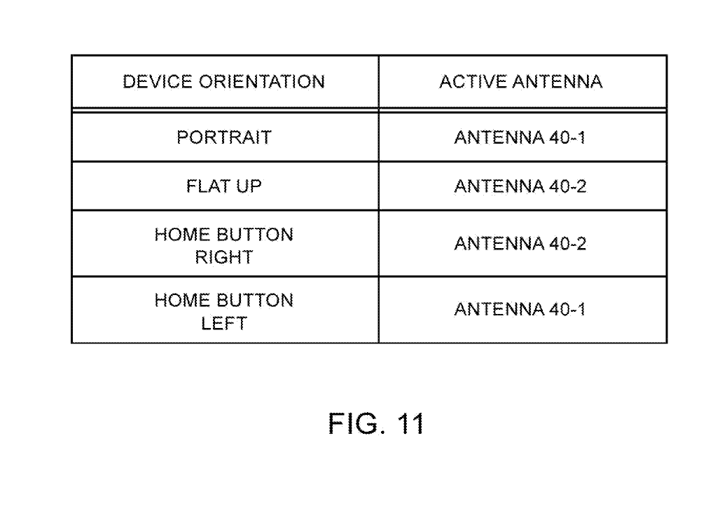

During operation, control circuitry 30 can use an accelerometer or other orientation sensor (e.g., one of sensors 32 of FIG. 2) to determine how device 10 is oriented relative to the Earth. Control circuitry 30 can then use a table of the type shown in FIG. 11 to determine which antenna should be switched into use by switching circuitry 124. As shown in FIG. 11, for example, if it is determined that device 10 has an orientation that most closely matching the portrait (antenna edge up) orientation of FIG. 5, control circuitry 30 can issue control commands to input 128 of switching circuitry 124 so that antenna 40-1 is switched into use. If device 10 is being used in the flat up orientation, control circuitry 30 can switch antenna 40-2 into use. Antenna 40-2 may also be switched into use in response to determining that device 10 is being held in a home button right orientation. In response to detecting that device 10 is in a home button left configuration, control circuitry 30 may direct switching circuitry 124 to switch antenna 40-1 into use. If desired, more than two antennas may be used in handling satellite navigation system signals and control circuitry 30 may switch a selected one of these antennas into use based on orientation information from an accelerometer or other orientation sensor. Control circuitry 30 may also make real time antenna selections based on received signal strength information (e.g., based information on whether the currently active antenna is receiving signals of adequate strength, based on information about whether the currently inactive antenna would offer a better signal strength than the currently active antenna, etc.).

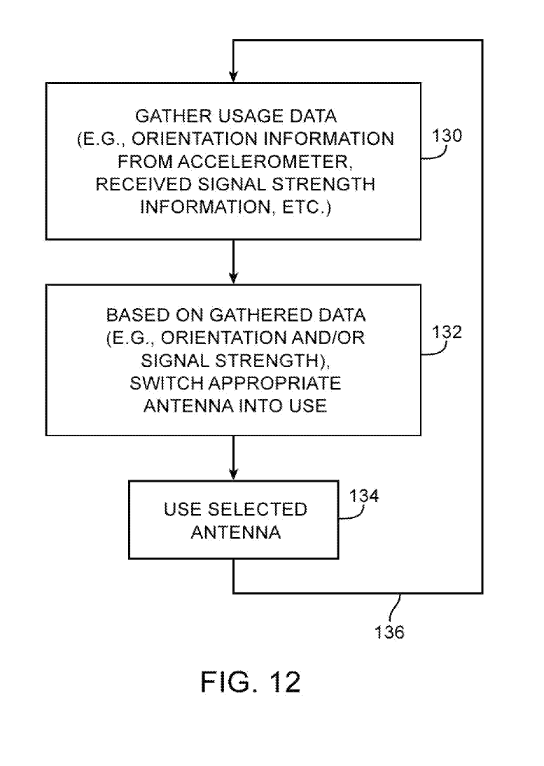

Illustrative steps involved in operating electronic device 10 of FIG. 11 are shown in FIG. 12. At step 130, device 10 can gather information on the current usage of device 10. For example, device 10 can use control circuitry 30 to gather sensor information from one or more sensors such a sensors 32 of FIG. 2 (e.g., an accelerometer, a connector sensor indicating whether device 10 has been plugged into a dock and is therefore in a portrait orientation), etc. Device 10 can also use control circuitry 30 to monitor signal strength information from receiver 42. If desired, control circuitry 30 can adjust switching circuitry 124 to take samples of the currently inactive antenna as well as taking signal strength samples from the active antenna. These two different signal strength samples can then be compared to determine which antenna is optimal.

Based on received signal strength information, orientation information, and other information, device 10 can switch an appropriate antenna into use (step 132). For example, control circuitry 30 may use a table such as the table of FIG. 11 or other criteria for determining which antenna should be switched into use to optimize satellite navigation system signal reception.

At step 134, satellite navigation system receiver 42 may receive and process satellite navigation system signals. Control circuitry 30 may use the position data associated with the received satellite signals to implement functions such as on-screen mapping, turn-by-turn directions, other location-based services, etc.

As shown by line 136, processing may loop back to step 130 (i.e., the operations associated with monitoring sensor and signal strength input and updating which antenna is selected for use as the currently active antenna may be performed continuously).

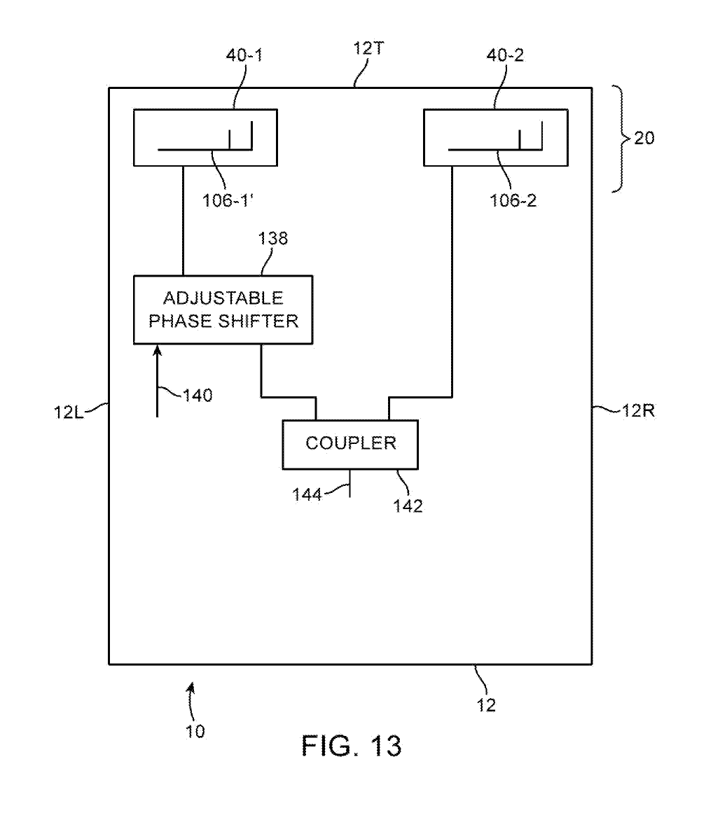

With another suitable arrangement, both antennas 40-1 and 40-2 are used simultaneously. This type of configuration for device 10 is shown in FIG. 13. The resonating elements of antennas 40-1 and 40-1 of FIG. 13 may be located along peripheral edge 12T of housing 12 and may have feeds that point in the same direction as shown by elements 106-1′ and 106-2. Configurations in which the feeds of the resonating elements for antennas 40-1 and 40-2 point in other directions may also be used.

Antenna 40-1 is coupled to a first input of coupler 142 and antenna 40-2 is coupled to a second input of coupler 142. A phase shifter such as phase shifter 138 is interposed in the path that couples antenna 40-1 to coupler 142. Output 144 of coupler 142 is coupled to satellite navigation system receiver 42. Phase shifter 138 may be an adjustable phase shifter that imposes an adjustable amount of phase shift between antennas 40-1 and 40-2. Control circuitry 30 may supply phase shifter control signals to control input 140 of phase shifter 138 to make phase adjustments in real time. The fixed phase offset between antennas 40-1 and 40-2 and phase shifts arising from phase adjustments made with phase shifter 138 will affect the performance of the antenna array made up of antennas 40-1 and 40-2. For example, the directionality and polarization of the antenna array may be affected by phase shift adjustments. These antenna attributes can be adjusted in real time to optimize satellite navigation system signal reception.

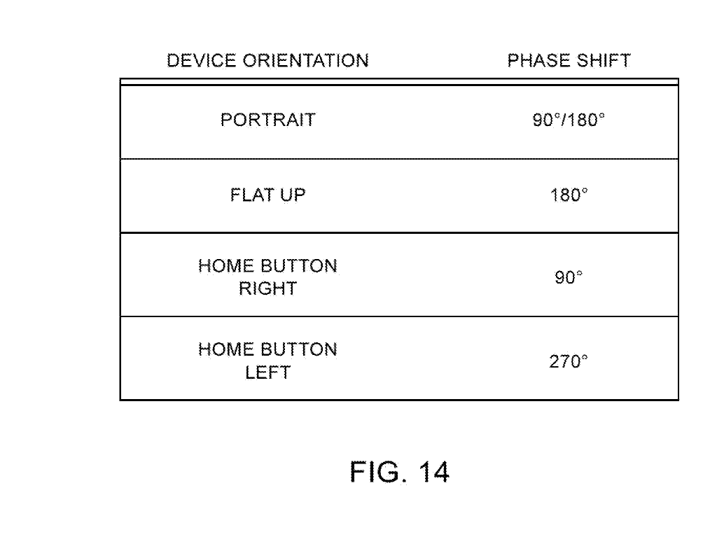

Antenna 40-1 may be associated with antenna currents in housing 12 that flow in a different direction than the antenna currents in housing 12 that are associated with antenna 40-2. For example, antenna currents associated with antenna 40-1 may be primarily horizontal, whereas antenna currents associated with antenna 40-2 may be primarily diagonal or vertical. As a result, antennas 40-1 and 40-2 will exhibit different polarizations. This allows the antenna array made up of antennas 40-1 and 40-2 to be adjusted in real time to efficiently receive circularly polarized signals of the type associated with satellite navigation system signals. Phase adjustments with phase shifter 138 may also affect the directionality of the antenna array made up of antennas 40-1 and 40-2. During characterization operations, the directionality of the antenna array made up of antennas 40-1 and 40-2 may be measured as a function of phase shift produced by phase shifter 138. This antenna characterization data may be used in forming tables of the type shown in FIG. 14. During operation of device 10, control circuitry 30 can use the information of the FIG. 14 table in determining how to make real time adjustments to phase shifter 138 to optimize the antenna array for receiving satellite navigation system signals.

As shown in the example of FIG. 14, control circuitry 30 can direct phase shifter 138 to produce different amounts of phase shift for each of four different device orientations. Device orientation may be monitored in real time using accelerometer data from an accelerometer.

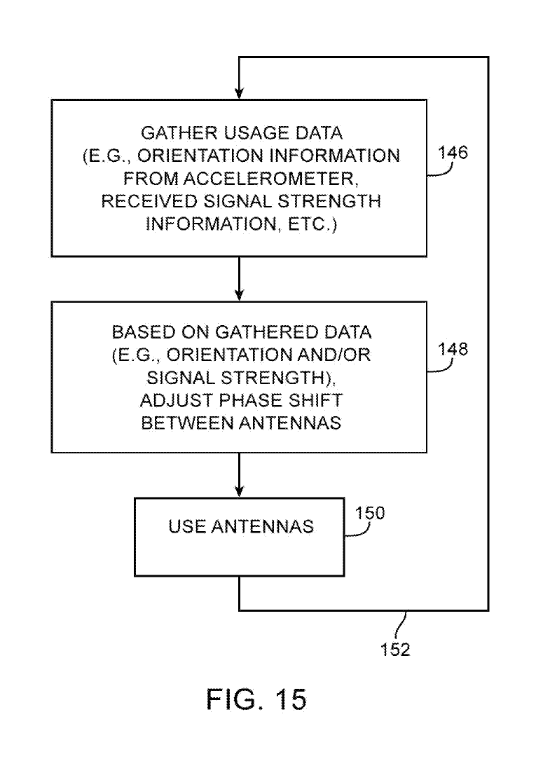

Illustrative steps involved in operating electronic device 10 of FIG. 13 are shown in FIG. 15. At step 146, device 10 can gather information on the current usage of device 10. For example, device 10 can use control circuitry 30 to gather sensor information from one or more sensors such a sensors 32 of FIG. 2 (e.g., an accelerometer, a connector sensor indicating whether device 10 has been plugged into a dock and is therefore in a portrait orientation), etc. Device 10 can also use control circuitry 30 to monitor signal strength information from receiver 42. Based on received signals strength information, orientation information, and other information, device 10 can adjust phase shifter 138 at step 148. For example, control circuitry 30 may use a table such as the table of FIG. 11 or other criteria for determining the phase shift that should be produced by phase shifter 138 as a function of measured device orientation to optimize satellite navigation system signal reception.

At step 150, satellite navigation system receiver 42 may receive and process satellite navigation system signals. Control circuitry 30 may use the position data associated with the received satellite signals to implement functions such as on-screen mapping, turn-by-turn directions, other location-based services, etc.

As shown by line 152, processing may loop back to step 146 (i.e., the operations associated with monitoring usage data such orientation sensor data and other data and making corresponding adjustments to phase shifter 138 may be performed continuously).

The foregoing is merely illustrative and various modifications can be made by those skilled in the art without departing from the scope and spirit of the described embodiments. The foregoing embodiments may be implemented individually or in any combination.

What is claimed is:

1. A portable electronic device, comprising:
an orientation sensor;
a first antenna;
a second antenna;
switching circuitry coupled to the first and second antennas;
a satellite navigation system receiver that is coupled to the switching circuitry; and
control circuitry that is configured to adjust the switching circuitry based on information from the orientation sensor to switch a selected one of the first and second antennas into use in receiving satellite navigation signals.

2. The portable electronic device defined in claim 1 wherein the first antenna comprises an inverted-F antenna.

3. The portable electronic device defined in claim 2 wherein the second antenna comprises an inverted-F antenna.

4. The portable electronic device defined in claim 3 further comprising a metal housing that forms an antenna ground for the first antenna and the second antenna.

5. The portable electronic device defined in claim 4 wherein the metal housing has four peripheral edges and wherein the first and second antennas are located along one of the four peripheral edges.

6. The portable electronic device defined in claim 5 wherein the control circuitry gathers received signal strength information from the satellite navigation system receiver and adjusts the switching circuitry based at least partly on the received signal strength information.

7. The portable electronic device defined in claim 5 further comprising:
a display mounted in the metal housing, wherein the display has a display cover layer with a portion that covers the first and second antennas.

8. A portable electronic device, comprising:
a first antenna;
a second antenna;
switching circuitry coupled to the first and second antennas;
a satellite navigation system receiver that is coupled to the switching circuitry; and
control circuitry that is configured to adjust the switching circuitry to switch an optimum one of the first and second antennas into use in receiving satellite navigation signals.

9. The portable electronic device defined in claim 8 wherein the control circuitry is configured to adjust the switching circuitry based on received signal strength information.

10. The portable electronic device defined in claim 9 wherein the control circuitry is configured to gather the received signal strength information from the satellite navigation system receiver.

11. The portable electronic device defined in claim 10 further comprising a metal electronic device housing.

12. The portable electronic device defined in claim 11 wherein the first antenna is formed from a first antenna resonating element and an antenna ground formed from the metal electronic device housing and wherein the second antenna is formed from a second antenna resonating element and the antenna ground.

13. The portable electronic device defined in claim 12 further comprising an orientation sensor that determines how the electronic device is oriented relative to the Earth, wherein the control circuitry is configured to adjust the switching circuitry based at least partly on information from the orientation sensor.

14. The portable electronic device defined in claim 12 wherein the first and second antennas are located along an edge of the metal electronic device housing.

15. The portable electronic device defined in claim 14 wherein the first and second antennas are inverted-F antennas.

16. A portable electronic device, comprising:
a first antenna;
a second antenna;
a coupler that is coupled to the first and second antennas;
a satellite navigation system receiver that is coupled to the coupler and that receives satellite navigation system signals from the first and second antennas through the coupler; and
an adjustable phase shifter interposed between the first antenna and the coupler.

17. The portable electronic device defined in claim 16 further comprising:
control circuitry that is configured to adjust the adjustable phase shifter.

18. The portable electronic device defined in claim 17 further comprising:
an orientation sensor, wherein the control circuitry is configured to adjust the adjustable phase shifter based on device orientation information from the orientation sensor.

19. The portable electronic device defined in claim 18 further comprising:
a metal electronic device housing having four peripheral edges, wherein the first and second antennas are located along one of the four peripheral edges.

20. The portable electronic device defined in claim 19 wherein the first antenna is formed from a first inverted-F antenna resonating element and an antenna ground formed from the metal electronic device housing and wherein the second antenna is formed from a second inverted-F antenna resonating element and the antenna ground.
